(19) United States
(12) Patent Application Publication
(10) Pub. No.: US 2016/0018245 A1
(43) Pub. Date: Jan. 21, 2016

(54) Measurement Using A Multi-Core Optical Fiber

(71) Applicant: Schlumberger Technology Corporation, Sugar Land, TX (US)

(72) Inventors: Tsutomu Yamate, Yokohama-shi (JP); Kamal Kader, Minato-ku (JP); Soon Seong Chee, Kokubunji-shi (JP); Toru Ikegami, Machida-shi (JP); Masafumi Fukuhara, Sagamihara-shi (JP); Nalin Weerasinghe, Imbulgoda (LK)

(21) Appl. No.: 14/799,586

(22) Filed: Jul. 15, 2015

Related U.S. Application Data
(60) Provisional application No. 62/025,493, filed on Jul. 17, 2014.

(51) Int. Cl. G01D 5/353; G01V 8/00; G02B 6/02

(52) U.S. Cl. CPC G01D 5/353; G02B 6/02042; G01V 8/00

(57) ABSTRACT

A system receives data corresponding to light signals in the plurality of cores, the plurality of cores including a first pair of cores spaced apart laterally along a first direction in the optical fiber, and a second pair of cores spaced apart laterally along a second direction in the optical fiber. The system determines a directional measurement of a dynamic parameter based on the data corresponding to light signals in the plurality of cores, wherein directionality of the directional measurement is indicated by a difference between a response of the first pair of cores to a stimulus and a response of the second pair of cores to the stimulus.

### BACKGROUND

An optical time domain reflectometry (OTDR) system can be used to measure values of a physical parameter of interest along an optical fiber. The optical fiber can be used as a distributed sensor. In some applications, an optical fiber can be deployed in a wellbore that is used to produce fluids from a reservoir in a subterranean structure, where the reservoir can include hydrocarbons, fresh water, or other fluids.

In other applications, an optical fiber can be used as part of a survey acquisition system to detect signals reflected from a subsurface structure. The optical fiber can be positioned above an earth surface, and signals reflected from the subsurface structure can be detected by the optical fiber.

### SUMMARY

In general, according to some implementations, data corresponding to light signals in a plurality of cores of a multi-core optical fiber is received. The plurality of cores include a first pair of cores spaced apart laterally along a first direction in the optical fiber, and a second pair of cores spaced apart laterally along a second direction in the optical fiber. A directional measurement of a dynamic parameter is determined based on the data corresponding to light signals in the plurality of cores, where directionality of the directional measurement is indicated by a difference between a response of the first pair of cores to a stimulus and a response of the second pair of cores to the stimulus.

Other or additional features will become apparent from the following description, from the drawings, and from the claims.

### BRIEF DESCRIPTION OF THE DRAWINGS

Some implementations are described with respect to the following figures.

FIG. 1 is a schematic diagram of an example measurement system, according to some implementations.

FIG. 2 is a schematic cross-sectional view of multiple cores in a multi-core optical fiber, according to some implementations.

FIG. 3 is a schematic side view of a portion of a multi-core optical fiber that is subjected to strain due to a stimulus, in accordance with some implementations.

FIG. 4 is a flow diagram of a process according to some implementations.

FIG. 5 is a schematic cross-sectional view of multiple cores in a multi-core optical fiber, according to further implementations.

FIG. 6 is a schematic cross-sectional view of multiple cores in a multi-core optical fiber, according to other implementations.

FIG. 7 is a schematic side view of a loop arrangement provided using a multi-core optical fiber, according to yet further implementations.

FIG. 8 is a block diagram of an example arrangement including one or more interrogation subsystems according to some implementations.

FIG. 9 is a block diagram of an example processing subsystem, according to further implementations.

### DETAILED DESCRIPTION

As used here, the terms “above” and “below”; “up” and “down”; “upper” and “lower”; “upwardly” and “downwardly”; and other like terms indicating relative positions above or below a given point or element are used in this description to more clearly describe some embodiments of the invention. However, when applied to equipment and methods for use in wells that are deviated or horizontal, such terms may refer to a left to right, right to left, or diagonal relationship as appropriate.

A distributed sensor that includes an optical fiber can be used to measure various parameters of interest, such as temperature, strain, and other parameters. In addition, a distributed sensor that includes an optical fiber can measure a dynamic parameter, such as vibration (due to dynamic change of strain), acoustic energy, and so forth. More generally, a dynamic parameter refers to a parameter whose change over time is of interest, rather than a parameter whose absolute value at a specific point in time is of interest. A distributed sensor can measure one or more parameters of interest at various points along the distributed sensor.

A distributed sensor including an optical fiber can be used to perform measurements in a wellbore, which is accomplished by deploying the distributed sensor in the wellbore. Measurements from the distributed sensor can be used to determine characteristics of an environment in the wellbore, or characteristics of a formation surrounding the wellbore. In other examples, a distributed sensor can be used to perform measurements in a surface survey operation, where the distributed sensor is provided at or above an earth surface to detect signals propagating from a subsurface structure. For example, the measurements of the surface survey operation can be used to determine the content of the subsurface structure, which can be underneath a land surface or under a water bottom surface (e.g. seabed). A marine survey operation involves deploying one or more survey sources and one or more distributed sensors in a body of water. A land survey operation involves deploying one or more survey sources and one or more distributed sensors on a land surface.

One type of subsurface surveying is seismic subsurface surveying, in which seismic signals generated by seismic sources are propagated into a subsurface structure. The propagated seismic signals are reflected from subsurface elements in the subsurface structure, where the reflected signals are detected by a distributed sensor.

Although reference is made to subsurface structures in the disclosure, it is contemplated that techniques or mechanisms according to some implementations can be applied to other types of target structures, such as human tissue, mechanical structures, plant tissue, animal tissue, solid volumes, substantially solid volumes, volumes of liquid, volumes of gas, volumes of plasma, and so forth.

An issue with measuring a dynamic parameter (e.g. vibration, acoustic energy, etc.) is that the directionality associated with a dynamic parameter may not be ascertainable using measurements by the distributed sensor. Directionality refers to a specific direction (or specific directions) of a physical parameter, such as a direction of a vibration or acoustic energy, as examples.

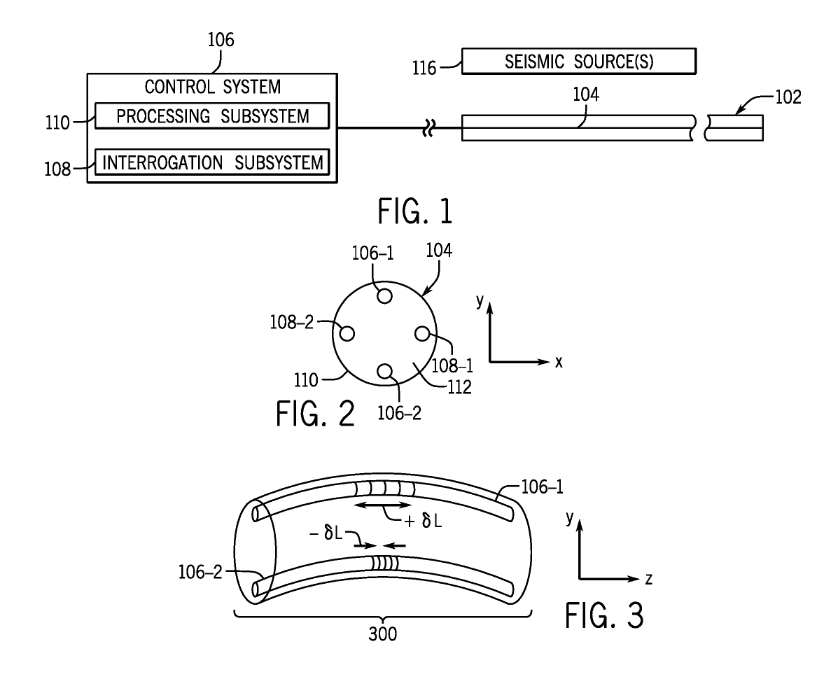

FIG. 1 is a schematic diagram of an example measurement system, which includes a distributed sensor 102 having an elongated optical fiber 104 (or multiple elongated optical fibers). The optical fiber 104 is connected to a control system 106 that has an interrogation subsystem 108 and a processing subsystem 110. The interrogation subsystem 108 is able to generate a light signal for emission into the optical fiber 104. The interrogation subsystem 108 also includes an optical receiver to receive, from the optical fiber 104, backscattered light that is responsive to the emitted light signal.

The processing subsystem 110 can process the received backscattered light to determine at least one parameter of interest, such as a dynamic parameter. The processing subsystem 110 can be implemented with a computer, or an arrangement of multiple computers.

The distributed sensor 102 can be deployed in a wellbore, or in different examples, the distributed sensor 102 can be used in a surface surveying operation, such as in a marine survey operation or a land-based survey operation to measure signals from a subsurface structure underneath an earth surface.

FIG. 1 shows one or multiple seismic sources 116 that can be provided for emitting seismic signals into the subsurface structure. Seismic signals reflected from the subsurface structure (in response to the seismic signals emitted by the one or more seismic signals) can be detected by the distributed sensor 102. Seismic signals can be detected by the distributed sensor 102 as a dynamic parameter, such as a vibration, acoustic energy, and so forth.

In accordance with some implementations, to allow for a determination of directionality of a dynamic parameter, the optical fiber 104 can be a multi-core optical fiber that has multiple cores. A core within an optical fiber refers to an optical communication medium along the length of the optical fiber 104 through which light can propagate. The multiple cores of the optical fiber 104 can independently propagate light.

FIG. 2 is a cross-sectional view of a portion of the optical fiber 104. The optical fiber 104 shown in FIG. 2 includes multiple cores 106-1, 106-2, 108-1, and 108-2. The multiple cores are included within an outer coating 110 of the optical fiber 104. The cores 106-1, 106-2, 108-1, and 108-2 are embedded in a clad material 112 contained inside the outer coating 110. Each core 106-1, 106-2, 108-1, and 108-2 includes a material, such as glass or plastic, that allows for propagation of light. The optical index of the clad material 112 and the optical index of each core are different to allow for propagation of light in the cores.

In the example of FIG. 2, the cores 106-1 and 106-2 are laterally spaced apart from each other along a y axis, while the cores 108-1 and 108-2 are laterally spaced apart along an x axis, which is generally perpendicular to the y axis. Note that the optical fiber 104 extends generally along a z direction (FIG. 3), which is perpendicular to both the x and y axes. A given direction (e.g. along x or y axis) along which cores are laterally spaced apart is generally perpendicular to a direction of a length of the optical fiber (e.g. along z axis)

In some examples, the cores 106-1, 106-2, 108-1, and 108-2 are placed as closely as possible to the outer clad 110 to increase the spacing between the cores in each pair. Placing a core as closely as possible to the outer clad 104 can refer to achieving a minimum spacing between the core and the outer clad 110, to within manufacturing tolerances. In other examples, the cores can be placed farther away from the clad 110.

In the ensuing discussion, reference is made to measurement of vibration. However, techniques or mechanisms according to some implementations can be applied for measurement of other types of dynamic parameters and/or other parameters.

Vibration can be induced by acoustic energy impacting the optical fiber. The acoustic energy can cause a portion of the optical fiber to be strained by the acoustic energy. A strain on the optical fiber portion can affect the backscattering of light through a respective core in the optical fiber.

As shown in FIG. 3, the strain on a portion 300 of the optical fiber 104 causes a bend in the optical fiber portion 300. As an example, the bend of the optical fiber portion 300 in FIG. 3 can be caused by vibration along the y axis. The bend of the optical fiber portion 300 results in different deformation of the cores 106-1 and 106-2, which are spaced apart from each other along the y axis. The core 106-1 is deformed by an amount +δL along the z axis, while the core 106-2 is deformed by amount −δL along the z axis. Thus, due to vibration propagating along the y axis, the deformation of cores 106-1 and 106-2 are opposite of each other. As a result, the phase shift of the light signal in the core 106-1 would be the opposite of the phase shift of a light signal in the core 106-2. Stated differently, the directional vibration (along the y axis) causes stretching deformation of the core 106-1, and squeezing deformation of the core 106-2.

The phase shift of the light signal in each of the cores 106-1 and 106-2 can be detected by using one of several reflectometry techniques. For example, a phase sensitive coherent optical time domain reflectometry (OTDR) technique can be used. The phase sensitive OTDR technique can extract phase information from backscattered signals from each core. A phase difference between regions of a core due to strain can be detected. Further details of an example phase sensitive coherent OTDR technique are provided in U.S. Publication No. 2013/0113629. In other examples, other techniques for detecting phase shift of light signals in the cores can be employed.

Vibration along the x axis can be detected by the spaced apart cores 108-1 and 108-2 in similar fashion.

Since the phase shift in the first core of a pair of spaced apart cores is the opposite of the phase shift of the second core of the pair of spaced apart cores, then a difference of the phase shifts in the pair of spaced apart cores results in a larger value. For example, due to strain on the optical fiber portion induced by vibration along the y axis, the phase shift in the core 106-1 can be +Δphase, while the phase shift in the core 106-2 can be −Δphase. The difference between +Δphase and −Δphase is 2Δphase, which is a larger value that results in enhanced sensitivity and better ability to detect directionality of the vibration.

Note that vibration along the y axis will result in a larger phase shift difference between light signals in the cores 106-1 and 106-2 (spaced apart along the y axis), as compared to phase shift difference between light signals in the cores 108-1 and 108-2 (spaced apart along the x axis). By comparing the phase shift difference between light signals of a first pair of cores with the phase shift difference between light signals of a second pair of cores, the processing subsystem 110 is able to determine the direction of the vibration.

Although reference is made to vibration along the y axis in the above discussion, it is noted that in other examples, vibration can be along a different direction, such as along the x direction, or along a direction that is angled with respect to the x and y directions. Techniques or mechanisms according to some implementations are able to detect the directionality of vibration in any of the foregoing directions.

In some examples, using the arrangement depicted in FIGS. 2 and 3, common noise such as noise due to temperature variations can be subtracted by taking the difference between the phase shifts and the light signals traveling in a pair of spaced apart cores. Thus, the determination of the directionality of vibration can be made independent of the temperature to which the optical fiber 104 is subjected. In this way, the determination of directionality of the vibration is not affected by temperature variations, or other environment conditions that may contribute to noise in measurements.

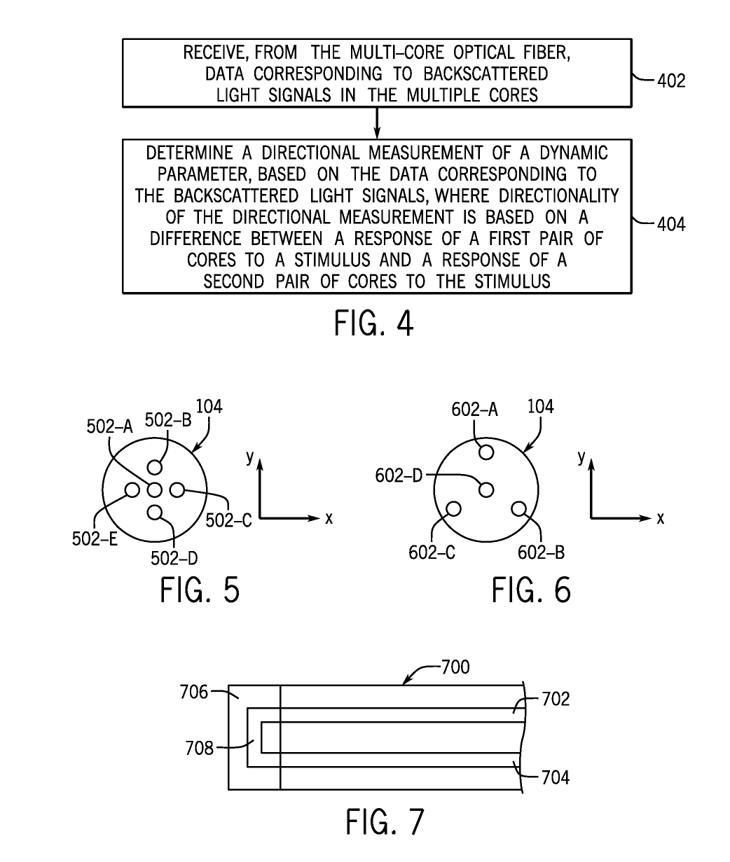

FIG. 4 is a flow diagram of a process that can be performed by the processing subsystem 110 (FIG. 1), according to some implementations, based on measurements acquired using the multi-core optical fiber 104 of FIG. 2. The processing subsystem 110 receives (at 402), from the multi-core optical fiber 104, data corresponding to backscattered light signals in the multiple cores. The processing subsystem 110 determines (at 404) a directional measurement of a dynamic parameter, such as vibration, based on the data corresponding to backscattered light signals in the multiple cores, where directionality of the directional measurement is indicated by a difference between a response of a first pair of cores to a stimulus and a response of a second pair of cores to the stimulus.

For example, the stimulus can include acoustic energy, and the response of the first or second pair of cores can include a phase difference of backscattered light signals in the pair of cores.

FIG. 5 is a cross-sectional view of a different arrangement of the multi-core optical fiber 104. In the arrangement of FIG. 5, five cores 502-A, 502-B, 502-C, 502-D, and 502-E are included inside the optical fiber 104. Light can propagate in the medium of each of the cores 502-A, 502-B, 502-C, 502-D, and 502-E. The core 502-A is arranged generally along the central longitudinal axis of the optical fiber 104. The cores 502-B, 502-C, 502-D, and 502-E are arranged close to the central core 502-A to increase crosstalk between each core 502-B, 502-C, 502-D, or 502-E and the central core 502-A.

The crosstalk between cores is caused by mode coupling between the cores. A measurement of mode coupling can include a mode-coupling coefficient. The concept of mode coupling between cores can be used to describe the propagation of light in an optical medium under the influence of an additional effect, such as an external stimulus or disturbance (e.g. acoustic energy). The basic concept of coupled-mode theory is to decompose propagating light into modes of an optical fiber that is undisturbed (i.e. not subjected to the external stimulus), and then calculate how these modes are coupled with each other when the optical fiber is subjected to the external stimulus. In some examples, the external stimulus can include acoustic energy.

Measurement of a mode-coupling coefficient can provide a vibration measurement. In some examples, a measurement technique can be made of mode coupling coefficients in a multi-core optical fiber based on Rayleigh backscattering (RBS) technique. An example of determining a mode-coupling coefficient in a multi-core optical fiber is described in JP Patent Application No. 2011-067754, entitled “Mode Coupling Measuring Method and Measuring Device for Multi-Core Optical Fiber,” filed Mar. 25, 2011. Another example of determining a mode-coupling coefficient in a multi-core fiber is described in Masataka Nakazawa et al., “Nondestructive Measurement of Mode Couplings Along a Multi-Core Fiber Using a Synchronous Multi-Channel OTDR,” May 2012.

In the example of FIG. 5, the cores 502-B and 502-D are spaced apart from the central core 502-A along the y axis, while the cores 502-C and 502-E are spaced apart from the central core 502-A along the x axis. In other examples, it is noted that instead of including two cores separated along a particular axis (e.g. x or y axis) to the central core 502-A, just one core can be separated along the particular axis to the central core 502-A. For example, the cores 502-D and 502-E can be omitted, leaving just the cores 502-A, 502-B, and 502-C.

In the presence of vibration along the y axis, the mode couplings between cores 502-A and 502-B and between cores 502-A and 502-D is more sensitive as compared to the mode couplings between cores 502-A and 502-C and between cores 502-A and 502-E. The processing subsystem 110 (FIG. 1) can compute the mode coupling coefficients for the mode couplings between cores 502-A and 502-E and between cores 502-A and 502-C, and can compute the mode coupling coefficients for the mode couplings between cores 502-A and 502-C and between cores 502-A and 502-E. The processing subsystem 110 can compare the mode coupling coefficient(s) for mode coupling(s) along a first direction (e.g. y direction) with the module coupling coefficient(s) for mode coupling(s) along a second direction (e.g. x direction). Based on the comparing of the mode coupling coefficients in the different directions, the directionality of a measured vibration can be determined. For example, the processing subsystem 110 can determine that the mode coupling coefficient(s) for the mode coupling(s) along the y direction is greater than the mode coupling coefficient(s) for the mode coupling(s) along the x direction. This condition is an indication that the vibration affecting the mode couplings is along the y direction.

In other examples, instead of computing the mode-coupling coefficients, a different propagation coefficient can be determined. When the distance between the cores are relatively small so that the coupled mode can propagate through a pair of the cores, the local strain on the optical fiber 104 can be measured by observing the propagation coefficient of the coupled mode (i.e. dispersion of the mode). The propagation coefficient of the coupled mode is dependent on the distance between the pair of the cores.

In some implementations, the propagation coefficient of a coupled mode can represent the speed and attenuation of light propagating in a pair of cores in coupled mode (where the light propagates in both cores in the pair in a coherent manner). The speed and attenuation (and hence the propagation coefficient) of light propagating in a pair of cores that are in coupled mode are different from the speed and attenuation of light propagating in the cores in non-coupled mode (i.e. the cores are sufficiently far apart such that coupled mode is not present).

In implementations where coupling mode coefficients or propagation coefficients are used to determine directionality of a dynamic parameter, the response of the first or second pair of the cores to a stimulus (as discussed in connection with task 404 in FIG. 4) includes the determined propagation mode coefficient(s) or propagation coefficient(s).

FIG. 6 is a cross-sectional view of a multi-core optical fiber 104 according to further implementations. In FIG. 6, different types of measurement techniques can be used to detect backscattered light in different cores. In the example of FIG. 6, cores 602-A, 602-B, 602-C, and 602-D are depicted. Although four cores are shown in FIG. 6, it is noted that in other examples, a different number of cores can be used, such as any number greater than or equal to two.

The following provides examples of specific measurement techniques for the different cores. In other examples, other types of measurement techniques can be used.

Backscattered light in the core 602-A can be measured using a Raman backscattering measurement technique, which can be used to measure temperature, for example. Backscattered light in the core 602-B can be measured using the phase sensitive OTDR technique discussed above, which can measure vibration and temperature. The combination of measured measurements made in the cores 602-A and 602-B can provide a temperature-corrected vibration measurement, for example. The processing subsystem 110 (FIG. 1) can use measurements of backscattered light in the core 602-A to ascertain temperature, and use measurements of backscattered light in the core 602-B to ascertain temperature and measurement. The effect of the measured temperature on the vibration can be removed by the processing subsystem 110 to provide the temperature-corrected vibration measurement.

As another example, a Brillouin scattering measurement technique can be used to measure backscattered light in the core 602-C. The Brillouin scattering measurement technique can provide measurements of strain and vibration, as well as temperature. The combination of measurements of backscattered light in core 602-A (using the Raman backscattering measurement technique) and the core 602-C (using the Brillouin scattering measurement technique) allows the processing subsystem 110 to derive a temperature-corrected strain or vibration measurement.

Brillouin scattering is an inelastic phenomenon that results from the interaction of incident optical photons (of an incident light signal) with acoustic phonons in the medium (the optical fiber core). This interaction induces a counter-propagating optical wave (reflected or backscattered optical signal) having a frequency (Brillouin frequency) that is shifted from the frequency of the original incident optical wave. Brillouin scattering in an optical fiber is sensitive to both temperature and strain changes in the optical fiber.

As another example, a fiber Bragg grating reflection (FBG) measurement technique can be used to measure backscattered light in the core 602-D. With the FBG measurement technique, reflectors are constructed in short segments of the fiber optic ore 602-D. Such a reflector (referred to as a Bragg reflector) includes a structured formed from multiple layers of alternating materials of varying refractive index. The Bragg reflector reflects particular wavelengths of light, and transmits the remaining wavelengths of light.

The FBG measurement technique can measure strain or vibration, as well as temperature. The combination of measurements from the core 602-A (using the Raman backscattering measurement technique) and core 602-D (using the FBG measurement), can provide a temperature-corrected strain or vibration measurement.

The measurements of light in the various cores of the multi-core optical fiber 104 of FIG. 6, using the different measurement techniques, can be performed concurrently by an interrogation subsystem, such as the interrogation subsystem 108 in FIG. 1. In this manner, a multi-parameter measurement can be made using the multi-core optical fiber 104 of FIG. 6.

FIG. 7 is a schematic diagram that shows how a loop measurement can be performed using the multi-core optical fiber 700, which can be a single-end optical fiber. In FIG. 7, the multi-core optical fiber 700 includes a first core 702 and a second core 704 in which light can be propagated. An optical connection component 706 is attached to the end of the optical fiber 104, where the optical connection component 706 includes a generally U-shaped optical medium 708. The U-shaped optical medium 708 can optically couple to the ends of the cores 702 and 704. A loop is created by attaching the optical connection component 706 to the optical fiber 104.

By using the loop configuration shown in FIG. 7, better signal-to-noise ratio can be achieved, since light propagated into one of the cores (e.g. 702) can propagate through the core 702, as well as travel around the U-shaped optical medium 708 back through the other core (e.g. 704). Thus, a double measurement can be made at any actual point along the length of the optical fiber 104, which means that a larger signal can be measured, to provide better signal-to-noise ratio.

In the various examples discussed above, reference has been made to measuring a dynamic parameter using the cores of a multi-core optical fiber. In further examples, it is noted that one or more cores of a multi-core optical fiber can be used to deliver optical power to a component coupled to the optical fiber. The component can covert the optical power to electrical power for use in powering electronic components.

Also, one or more cores of the multi-core optical fiber can be used to perform data telemetry. Optical signals can be carried in a core to carry data between communication components coupled to the optical fiber.

As an example, the interrogation subsystem 108 of FIG. 1, or a different subsystem, can be used for delivering optical power and/or performing data telemetry.

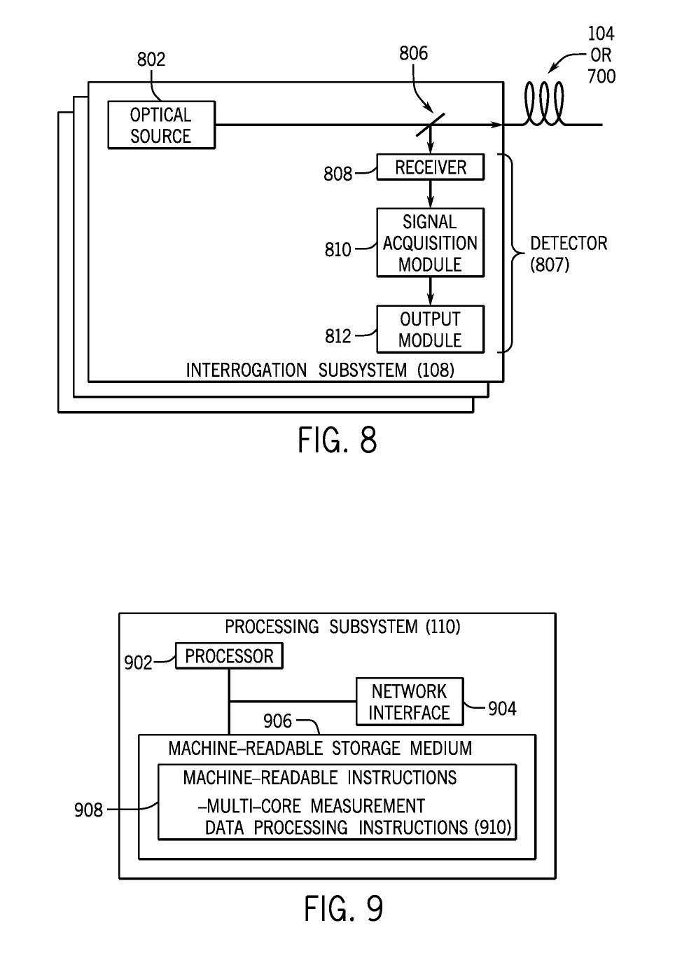

FIG. 8 shows an example of one or more interrogation subsystems 108, according to some implementations. Each interrogation subsystem 108 includes an optical source 802 that generates an optical signal, such as an optical pulse (or sequence of optical pulses), for interrogating an optical fiber 104 or 700 in a distributed sensor.

The pulses emitted by the optical source 802 are launched into the optical fiber 104 or 700 through a directional coupler 806, which separates outgoing and returning optical signals and directs the returning (backscattered) signals to an optical receiver 808. The directional coupler 806 may be a beam splitter, a fiber-optic coupler, a circulator, or some other optical device.

The backscattered optical signals returned from the optical fiber 104 or 700 in response to interrogating pulses may be detected and converted to an electrical signal at the optical receiver 808. This electrical signal may be acquired by a signal acquisition module 810 (e.g., an analog-to-digital converter) and then transferred as data representing the backscattered signals to an output module 812 for outputting the data to the processing subsystem 110 of FIG. 1. The receiver 808, the signal acquisition module 810, and the output module 812 can collectively be referred to a detector 807.

It is noted that certain components in the transmission path or receive path of the interrogation subsystem 108 have been omitted to simplify the discussion. Such components may include a modulator, a demodulator, an amplifier, a filter, and so forth.

In some implementations, multiple interrogation subsystems 108 can be provided, such as in implementations employing the multi-core optical fiber 104 of FIG. 6 that employs different types of measurement techniques for the different cores of the multi-core optical fiber. The multiple interrogation subsystems 108 can employ different types of measurement techniques for measuring backscattered light from the different cores. In other examples, instead of employing multiple interrogation subsystems 108, multiple detectors 807 can instead be used for measuring backscattered light from the multiple cores of the multi-core optical fiber 106 of FIG. 6, where the multiple detectors 807 can employ different types of measurement techniques.

FIG. 9 is a block diagram of an example processing subsystem 110 according to some implementations. The processing subsystem 110 includes one or more processors 902, which can be coupled to a network interface 904 (to allow the processing subsystem 110 to communicate over a network) and a non-transitory machine-readable storage medium (or storage media) 906. A processor can include a microprocessor, microcontroller, processor module or subsystem, programmable integrated circuit, programmable gate array, or another control or computing device.

The storage medium (or storage media) 906 can store machine-readable instructions 908 that are executable on the one or more processors 902. The machine-readable instructions 908 can include multi-core measurement data processing instructions 910, to process measurements by the various multi-core optical fibers discussed above and detected by the interrogation subsystem 108.

The storage medium (or storage media) 906 can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system including a processor, data corresponding to light signals in a plurality of cores of a multi-core optical fiber, the plurality of cores including a first pair of cores spaced apart laterally along a first direction in the optical fiber, and a second pair of cores spaced apart laterally along a second direction in the optical fiber; and
determining, by the system, a directional measurement of a dynamic parameter based on the data corresponding to light signals in the plurality of cores, wherein directionality of the directional measurement is indicated by a difference between a response of the first pair of cores to a stimulus and a response of the second pair of cores to the stimulus.

2. The method of claim 1, further comprising:
determining the response of the first pair of cores by computing a difference between a phase shift of a backscattered light signal in a first core of the first pair of cores, and a phase shift of a backscattered light signal in a second core of the first pair of cores;
determining the response of the second pair of cores by computing a difference between a phase shift of a backscattered light signal in a first core of the second pair of cores, and a phase shift of a backscattered light signal in a second core of the second pair of cores.

3. The method of claim 1, wherein the stimulus is a directional stimulus along a given direction, the directional stimulus causing stretching deformation of a first core of the first pair of cores, and squeezing deformation of a second core of the first pair of cores.

4. The method of claim 1, wherein the dynamic parameter comprises one of vibration and acoustic energy.

5. The method of claim 1, wherein the determined directional measurement of the dynamic parameter is independent of an environment condition of an environment surrounding the multi-core optical fiber.

6. The method of claim 1, wherein determining the directional measurement of the dynamic parameter is based on measurements of mode coupling coefficients of the respective first and second pairs of cores, each mode coupling coefficient representing mode coupling between a respective pair of the first and second pairs of cores.

7. The method of claim 1, wherein determining the directional measurement of the dynamic parameter is based on measurements of propagation coefficients of a coupled mode of the respective first and second pairs of cores, the propagation coefficient representing a speed and attenuation of light propagating in a respective pair of cores in coupled mode.

8. A system comprising:
a multi-core optical fiber including a plurality of cores; and
a measurement subsystem comprising:
a first detector to utilize a first type of optical measurement technique to measure a parameter in a first of the plurality of cores, and
a second detector to utilize a second, different type of optical measurement technique to measure a parameter in a second of the plurality of cores.

9. The system of claim 8, wherein the first type of optical measurement technique is an optical measurement technique selected from the group consisting of a Raman backscattering technique, a Brillouin scattering technique, a coherent Rayleigh noise scattering technique, and a Fiber Bragg Grating reflection technique, and the second type of optical measurement technique is a different optical measurement technique selected from the group consisting of a Raman backscattering technique, a Brillouin scattering technique, a coherent Rayleigh noise scattering technique, and a Fiber Bragg Grating reflection technique.

10. The system of claim 9, wherein the measurement subsystem further comprises a third detector to utilize a third type of optical measurement technique to measure a parameter in a third of the plurality of cores, the third type of optical measurement technique different from the first and second types of optical measurement techniques.

11. The system of claim 8, wherein the first and second optical detectors are configured to concurrently measure multiple parameters.

12. A system comprising:
a multi-core optical fiber including a plurality of cores; and
a processing subsystem configured to:
receive data corresponding to light signals in the plurality of cores, the plurality of cores including a first pair of cores spaced apart laterally along a first direction in the optical fiber, and a second pair of cores spaced apart laterally along a second direction in the optical fiber; and
determine a directional measurement of a dynamic parameter based on the data corresponding to light signals in the plurality of cores, wherein directionality of the directional measurement is indicated by a difference between a response of the first pair of cores to a stimulus and a response of the second pair of cores to the stimulus.

13. The system of claim 12, wherein the multi-core optical fiber has a portion extending along a given direction, wherein the first direction is generally perpendicular to the given direction, and the second direction is generally perpendicular to the given direction, and he first direction is generally perpendicular to the second direction.

14. The system of claim 12, wherein the stimulus is a directional stimulus along a given direction, the directional stimulus causing stretching deformation of a first core of the first pair of cores, and squeezing deformation of a second core of the first pair of cores.

15. The system of claim 12, wherein the dynamic parameter comprises one of vibration and acoustic energy.

16. The system of claim 12, wherein the determined directional measurement of the dynamic parameter is independent of an environment condition of an environment surrounding the multi-core optical fiber.

17. The system of claim 12, wherein determining the directional measurement of the dynamic parameter is based on measurements of mode coupling coefficients of the respective first and second pairs of cores, each mode coupling coefficient representing mode coupling between a respective pair of the first and second pairs of cores.

18. The system of claim 12, wherein determining the directional measurement of the dynamic parameter is based on measurements of propagation coefficients of a coupled mode of the respective first and second pairs of cores, the propagation coefficient representing a speed and attenuation of light propagating in a respective pair of cores in coupled mode.

19. The system of claim 12, further comprising:
an optical connection component optically coupled to an end of the multi-core optical fiber to optically connect at least two of the plurality of cores.

20. The system of claim 12, further comprising a subsystem to one or both of: deliver optical power over at least one core of the plurality of cores, and perform data telemetry using optical signals communicated over at least one core of the plurality of cores.
